(19) United States
(12) Patent Application Publication
(10) Pub. No.: US 2004/0091213 A1
(43) Pub. Date: May 13, 2004

(54) Optical calibrating method

(76) Inventors: Tsung-Kai Chuang, Tai-Nan City (TW); Chien-Ho Chuang, Kao-Hsiung City (TW); Tzu-Chiang Wu, Miao-Li City (TW)

Correspondence Address: SUPREME PATENT SERVICES, POST OFFICE BOX 2339, SARATOGA, CA, 95070, US

(21) Appl. No.: 10/290,986

(22) Filed: Nov. 8, 2002

(51) Int. Cl. G02B 6/00

(52) U.S. Cl. 385/52; 385/147

(57) ABSTRACT

This invention is an optical calibration method characterized in calibrating the position of a light-permeable article automatically that is applicable to a light-permeable article positioned on an optical calibrating machine base having a platform for calibration, a transmission end, a receiver end, an adjustable laser device, and a power meter or a spectrometer.

### FIELD OF THE INVENTION

The invention is an optical calibration method that satisfies the need for optical calibration of light-permeable articles when testing DWDM (dense wavelength division multiplexing) components such as thin film filters, collimators, wave guides, etc., that are utilized in the photoelectric industry. This invention reduces the measurement time as well as the instability and inaccuracy of human manipulation and, thereby, raises the quality and production yield.

### BACKGROUND OF THE INVENTION

Snell's law is a well-known important law in geometrical optics that can predict the situation when light passes through different media as shown in FIG. 1.

In FIG. 1, an incident ray projects onto a first medium then on a second medium. In this case, one part of the ray reflects, and the other part penetrates, in which θi, θr, and θt represent an angle of incidence, an angle of reflection, and an angle of refraction, respectively, while n1 and n2 are the refractive index of the first and the second medium, respectively. According to Snell's law, the following relationship is established between those θs and ns:

θi=θr; n1sin θi=n2sin θt,

and accordingly, to exemplify light reflection with a laser beam and measure the refractive index of a light-permeable article is possible.

### SUMMARY OF THE INVENTION

The primary object of this invention is to provide a simple, fast, and effective optical calibration method to fulfill the need of optical calibration of light-permeable articles such as DWDM filters, thin film filters, collimators, or wave guides, etc., in the photoelectric industry. By using this method, it is possible to reduce the measurement time and eliminate the instability and inaccuracy of human manipulation and thereby increase the quality and the production yield.

For more detailed information regarding advantages or features of this invention, at least an example of preferred embodiment will be fully described below with reference to the annexed drawings.

### BRIEF DESCRIPTION OF THE DRAWINGS

Drawings included with the detailed description of this invention are described as follows:

FIG. 1 shows light passing through various media;

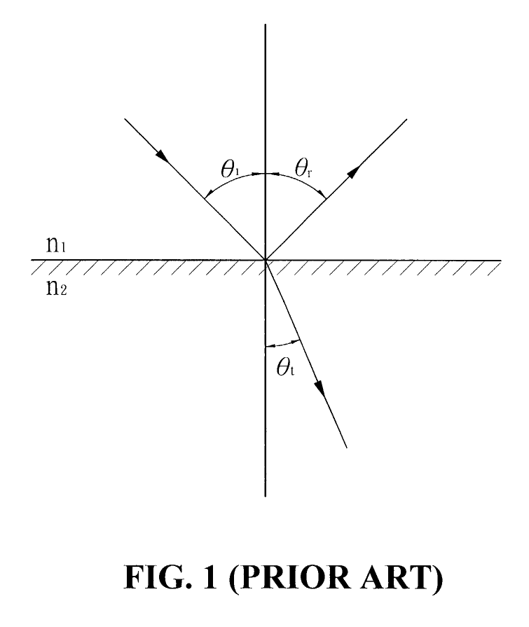

FIG. 2 shows the framework of a measurement system utilizing the optical calibration method described by this invention;

FIG. 3 shows the framework of a measurement system utilizing the optical calibration method described by this invention in more detail;

FIG. 4 shows the general processing steps of the optical calibration method of this invention;

FIG. 5 is a schematic view showing the permeability ratio of a laser beam vs wavelength by utilizing the method of this invention;

FIG. 6A shows a detailed flowchart of a preferred embodiment of this invention; and

FIG. 6B is a continuation part of FIG. 6A.

### DETAILED DESCRIPTION OF THE INVENTION

The invention is an optical calibration method applicable to light-permeable articles such as DWDM filters, TFFs (thin film filter), collimators, or wave-guides. This method utilizes an optical calibration machine base that consists of a platform for calibration, a transmission end, a receiver end, an adjustable laser device, and a power meter or a spectrometer such that the receiver end is enabled to receive the penetrative light with a best calibration effect.

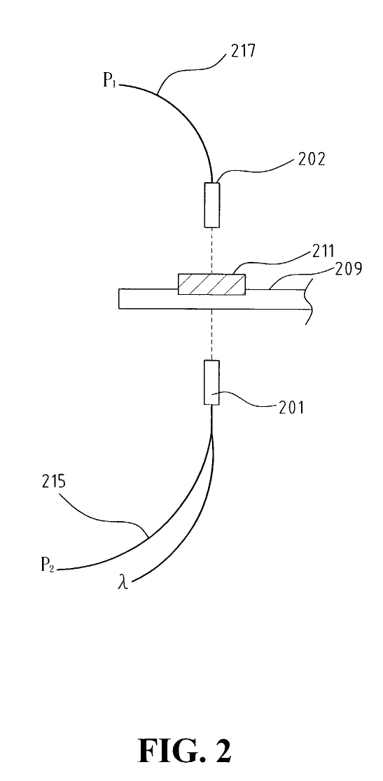

The framework of a measurement system utilized in this invention is shown in FIG. 2. As indicated in FIG. 2, a light-permeable article 211 is located on a platform for measurement 209. The light-permeable article 211 could be a DWDM filter, a TFF, a collimator, or a wave-guide, etc. A transmitter and a receiver end 201/202 are separated on respective sides of the light-permeable article 211, in which the transmitter end 201 is connected to an optical-fiber cable 215 for receiving the light from a light source (λ). The light is then emitted from the transmitter end 201 to reach the receiver end 202 through the light-permeable article arranged on the platform. One end of the receiver end 202 is connected to an optical-fiber cable 217. The other end of the optical-fiber cable 217 is connected to a power meter P1, or to a spectrometer, which is connected to a computer via a GPIB 314. The computer then determines whether the light-permeable article has arrived at a correct position for calibration.

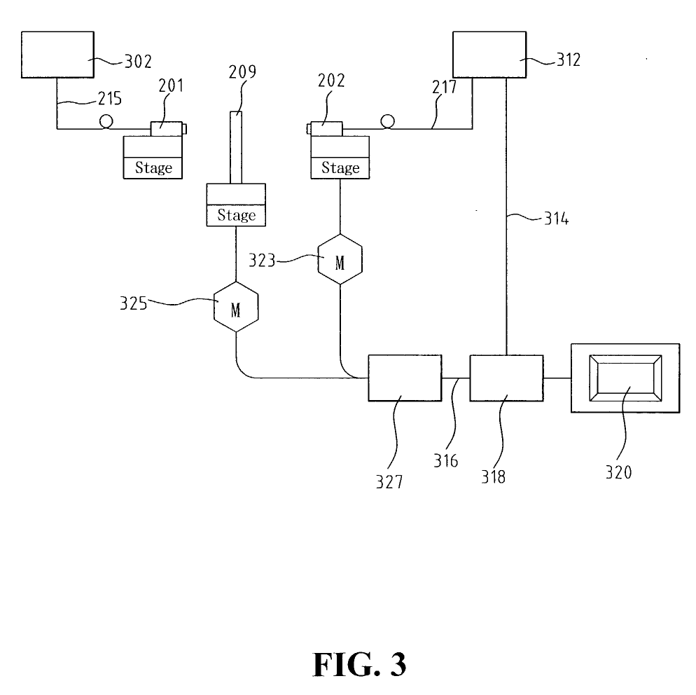

FIG. 3 shows the framework of a measurement system utilized by the optical calibration method described by this invention in more detail. In FIG. 3, a light-permeable article (not shown) is placed on the platform for calibration 209. The article could be a DWDM filter, a TFF (thin film filter), a collimator, or a wave-guide. A transmitter and a receiver end 201/202 are separated on respective sides of a light-permeable article 211, in which the transmission end 201 is connected to an optical-fiber cable 215 for receiving the light from a light source 302. The light is then emitted from the transmission end 201 to reach the receiver end 202 through the light-permeable article arranged on the platform. One end of the receiver end 202 is connected to an optical-fiber cable 217, and the other end of the optical-fiber cable 217 is connected to a power meter 312. The power meter 312 forwards a measured power value to a computer 318 via a GP1B 314. The computer 318, which is connected to a monitor 320, would display the present receiving state of the power. The computer is connected, via another GPIB 316, to a stepper motor controller 327, which controls the motor 323/325. This motor is located at the receiver end 202 and on the platform 209, and is utilized to ensure that the light-permeable article has been moved to a correct position for calibration.

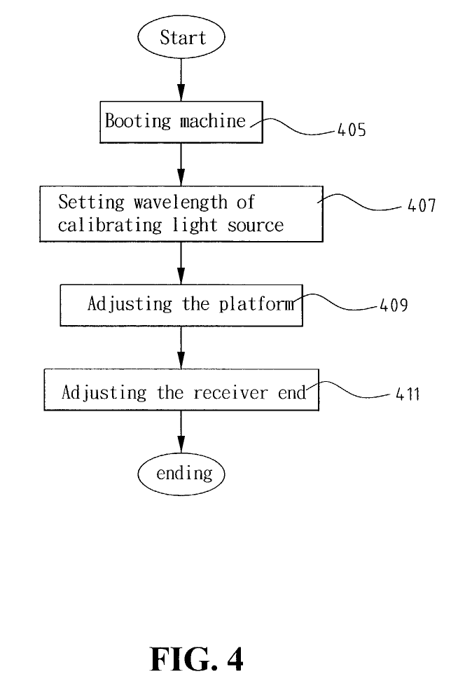

FIG. 4 shows the general processing steps of the optical calibration method described by this invention. As the calibration method of this invention is performed automatically in moving the light-permeable article, it is necessary to start the machine at the very beginning 405 as well as to start the hardware and to load and initialize the drivers.

This invention optimizes the calibration photo intensity and wavelength passed through a pending-measuring article by measuring the photo power ratio to find out a corresponding largest wavelength. In order to optimize the search of a frequency spectrum, this invention is set to a relatively narrow frequency spectrum as a main scope to facilitate the search for the larger wavelength. This larger wavelength is the so-called center wavelength represented by λc, and is the proper detection position as well as the largest penetrative power value, according to the optical properties of a pending-measuring article. A boundary portion left to the narrow frequency spectrum is defined as λ1 while the other boundary portion on the right side as λ2. Searching is conducted from one boundary to the other by increasing or decreasing gradually an infinitesimal change of wavelength every time to find the suitable optical wavelength for an optimum calibration 407.

During the calibration process, it is necessary to rotate and/or move the platform and the receiver end for adjustment. In this case, a preferred embodiment of this invention is to rotate and/or move the platform 409 before the receiver end 411. However, there is no preference in either rotating the platform or moving the receiver end.

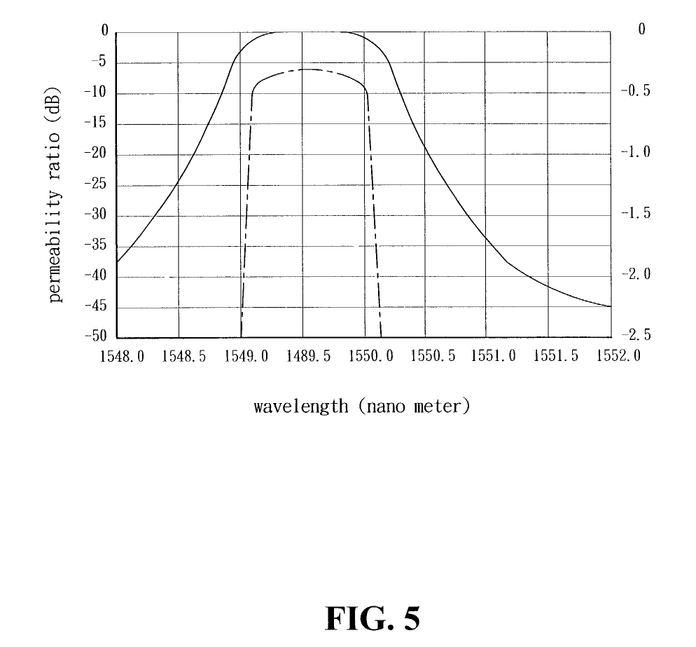

FIG. 5 is a schematic view showing the received permeable ratio of laser vs wavelength by utilizing the method of this invention, which is plotted on the basis of the optimum wavelengths for calibration and the distribution of light permeable ratio according to various detection locations. As shown in FIG. 5, the solid line encloses the power measured by a power meter, and the attenuation thereof is logarithmic and represented by permeable ratio T (dB) in Y-axis (vertical coordinates). The power attenuation can be obtained according to the formula: dB=10log[P/1 mW]. For example, if power is attenuated to remain 50% (0.5 mW) to a mean power attenuation of −3 dB, or remain 10% to mean −10 dB.

The X-axis represents the light wavelength (nm) to be calibrated. The dotted line encloses an enlarged view of wavelengths between 1550.0 nm and 1550.2 nm.

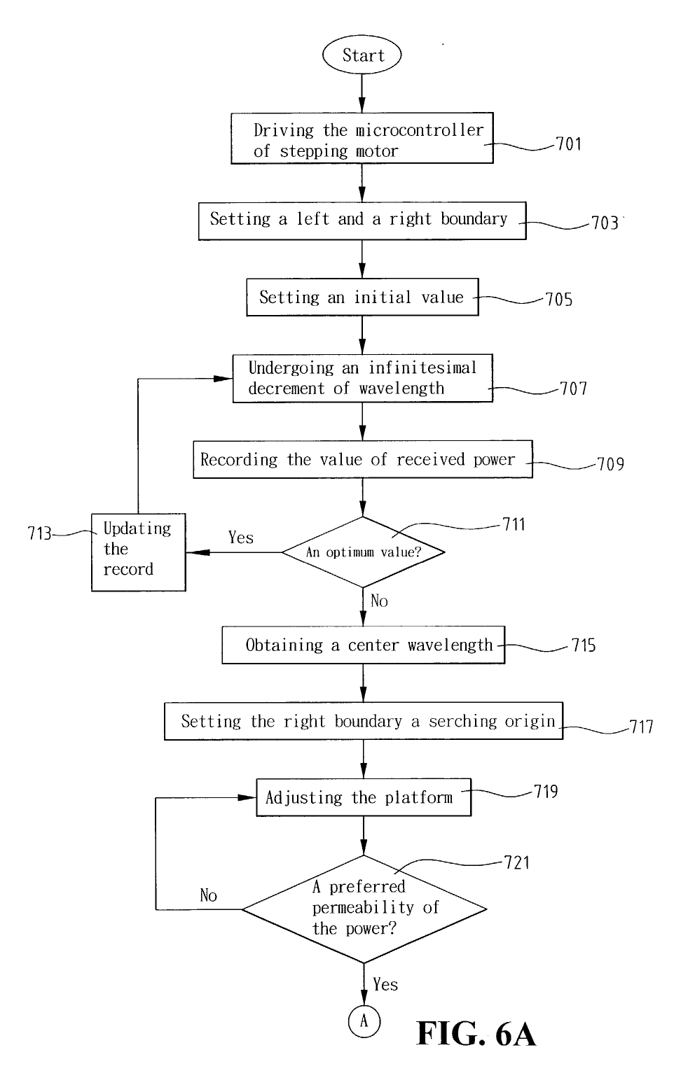

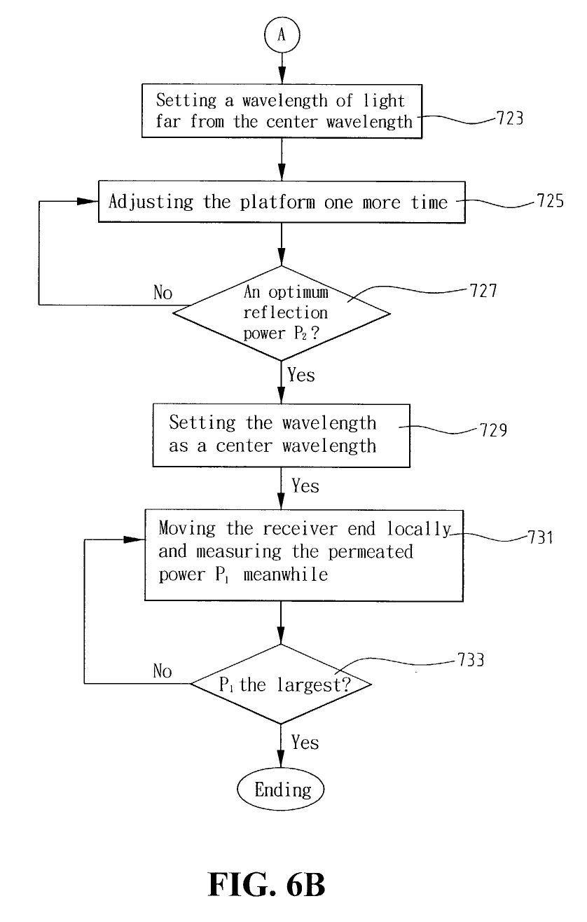

FIG. 6A shows a detailed flowchart of a preferred embodiment of this invention. The flowchart starts with a step to set a stepping motor microcontroller in a stand-by state (701). Next, a search range of frequency spectrum is set for a fast search of optimum wavelengths for calibration. A left and a right boundary (703) is defined as λ1 and λ2, respectively, then the range is scanned from one boundary to the other with an infinitesimal change of increment or decrement in wavelength in order to find the optimum wavelength for calibration. In a preferred embodiment of this invention, search is made from the right boundary λ2 toward the left, hence, it is required to set the value to be sought as λ, namely λ=λ2, as well as an initial value (705). The wavelength is decreased by a change Δλ of wavelength every time (707). After light is emitted from the transmitter end, it would pass through the light-permeable article on the platform to reach the receiver end, of which one end is connected to an optical-fiber cable, and the other end of the optical-fiber cable is connected to a power meter. A step (711) is where the value of received power (as P1, new) (709) detected by the power meter is recorded, then compared with a previous value (P1, old) to find the optimal value. If positive, the following step is where the previous value (P1, old) is updated into (P1, new) and reversed, otherwise the previous value is the optimum wavelength.

In the step (707), Δλ has been decremented in advance, it is therefore necessary to return back a Δλ for returning to the center frequency λc (715).

Similarly, in the following step, The right boundary λr is set as a start point for searching the wavelengths toward the left. The position of the platform is adjusted with a stepping motor (719) in order to optimize the measured power values of the penetrating light and variations of wavelength in order to optimize the calibration position of the largest light permeability on the platform (721). FIG. 6B is a continuation part of FIG. 6A. In FIG. 6B, a further step (723) is taken to set the wavelength value of light away from the center wavelength, then adjust the position of the platform one more time (725) for confirmation and to measure the power value until the largest value corresponding to an optimum calibrating position of the platform is obtained (727). Several further steps performed before ending this method shall include: setting the wavelength of light as the center wavelength (729); adjusting the position and angle of the receiver end (731); and searching for the largest value of permeated power to ensure that the receiver end is in a optimum calibrating position (733) that has the minimum reflection or refraction index.

In the above described, at least one preferred embodiment has been described in detail with reference to the drawings annexed, and it is apparent that numerous changes or modifications may be made without departing from the true spirit and scope thereof, as set forth in the claims below.

What is claimed is:

1. An optical calibrating method applicable to light-permeable articles for optical calibration, the method, incorporated with an optical calibrating machine base having a calibrating platform, a transmission end, a receiver end, an adjustable laser device, and a power meter or a spectrometer, comprising:
searching with said power meter the light emitted from a transmission end and permeated through a light-permeable article on said calibrating platform to reach and penetrate said receiver end for the wavelength of light with a largest permeability ratio;
moving and/or rotating said platform such that the light emitted from said transmission end and permeated through the light-permeable article on said calibrating platform to reach said receiver end and reflect therefrom has a largest reflection ratio; and
outputting the position and/or angle of the light-permeable article.

2. The method according to claim 1, in which said searching step for the largest wavelength of a laser beam comprises a step of constraining search range of the laser wavelength.

3. The method according to claim 1, further comprising a step for a multi-shaft stepping motor to move and/or rotate the position and angle of said platform, the step including:
providing an operation interface for setting parameters of each shaft in said multi-shaft stepping motor;
setting parameters of each shaft in said multi-shaft stepping motor; and
storing the codes created by the parameters of each shaft in said multi-shaft stepping motor.

4. The method according to claim 3, in which said multi-shaft stepping motor is employed for controlling the position of said receiver end.

5. The method according to claim 3, in which said multi-shaft stepping motor is employed for controlling the angle of said receiver end.

6. The method according to claim 3, in which said multi-shaft stepping motor is employed for controlling the position of said platform.

7. The method according to claim 3, in which said multi-shaft stepping motor is employed for controlling the angle of said platform.

8. The method according to claim 1, in which light is permitted to penetrate through said light-permeable article to conform to the Snell's law.

9. The method according to claim 8, in which said light-permeable article is a DWDM (dense wavelength division multiplexer) filter.

10. The method according to claim 8, in which said light-permeable article is a thin film filter (TFF).

11. The method according to claim 8, in which said light-permeable article is a collimator.

12. The method according to claim 8, in which said light-permeable article is a wave guide.
